(19) United States
(12) Patent Application Publication
(10) Pub. No.: US 2026/0142491 A1
(43) Pub. Date: May 21, 2026

(54) SYSTEMS AND METHODS FOR RECHARGEABLE POWER UNITS WITH MULTIDIRECTIONAL CHARGING PINS FOR ORIENTATION-AGNOSTIC CHARGING

(71) Applicant: Tricopian, Inc., Del Mar, CA (US)

(72) Inventor: Chi W. Yau, Escondido, CA (US)

(21) Appl. No.: 19/390,306

(22) Filed: Nov. 14, 2025

Related U.S. Application Data
(60) Provisional application No. 63/721,366, filed on Nov. 15, 2024.

(51) Int. Cl. H02J 7/00; H01M 10/44

(52) U.S. Cl. CPC H02J 7/96; H01M 10/441; H02J 7/731; H02J 7/80

(57) ABSTRACT

Systems and methods for are disclosed for multidirectional charging of rechargeable power unit. In some embodiments, a kiosk with a multidirectional charging cradle may receive multidirectional rechargeable power units in need of a charge. The multidirectional charging cradle supports orientation-agnostic charging through use of multidirectional charging pins on the rechargeable power unit and corresponding multidirectional contacts within slots of the charging cradle, managed by a control circuitry in connection with a power supply for the charging cradle. Multidirectional rechargeable power units may comprise a positive pin and two negative pins to be used interchangeably for a flow path within the charging cradle.

### RELATED APPLICATIONS

This application claims the benefit of U.S. Provisional Patent Application No. 63/721,366, filed on Nov. 15, 2024. The entire contents of the above-application is hereby incorporated by reference and made a part of this specification. Any and all priority claims identified in the Application Data Sheet, or any correction thereto, are hereby incorporated by reference under 37 CFR 1.57.

### BACKGROUND

This disclosure relates to the field of portable, rechargeable, electric power supplies.

### SUMMARY

In some aspects, the techniques described herein relate to a charging system including: a multidirectional charging cradle configured to receive one or more rechargeable power units, the multidirectional charging cradle including a first electrical contact configured to have a first polarity, and a plurality of second electrical contacts configured to have a second polarity; and a control unit in communication with the multidirectional charging cradle, the control unit configured to apply voltages to the first electrical contact and one of the plurality of second electrical contacts based on an orientation of a rechargeable power unit disposed within the multidirectional charging cradle.

In some aspects, the techniques described herein relate to a system, wherein the multidirectional charging cradle includes a plurality of slots, each slot of the plurality of slots configured to accept a rechargeable power unit.

In some aspects, the techniques described herein relate to a system, wherein the first electrical contact configured to have the first polarity is a positive polarity contact, and wherein the plurality of second contacts configured to have a second polarity includes a first negative contact and a second negative contact.

In some aspects, the techniques described herein relate to a system, wherein the first negative contact and the second negative contact are arranged opposite to one other on either side of the positive polarity contact.

In some aspects, the techniques described herein relate to a multidirectional power unit kiosk, wherein the control unit is configured to identify which of the first negative contact and the second negative contact is in electrical connection with a negative terminal of the rechargeable power unit, and to apply a negative voltage to the identified one of the first negative contact and the second negative contact.

In some aspects, the techniques described herein relate to a multidirectional power unit kiosk, wherein the control unit is configured to identify an orientation of a rechargeable power unit and apply a voltage to one of the first negative contact and the second negative contact that is engaged with a negative electrical contact of the rechargeable power unit.

In some aspects, the techniques described herein relate to a multidirectional power unit kiosk, wherein the control unit is configured to identify an orientation of a rechargeable power unit and neutralize one of the first negative contact and the second negative contact that is not engaged with a negative electrical contact of the rechargeable power unit.

In some aspects, the techniques described herein relate to a multidirectional power unit kiosk, wherein the control unit is configured to run diagnostic programs on rechargeable power units to determine battery health prior to charging.

In some aspects, the techniques described herein relate to a system for charging rechargeable power units, the system including: a kiosk including a multidirectional charging cradle configured to receive one or more rechargeable power units, the multidirectional charging cradle including a plurality of first electrical contacts; and a multidirectional power unit configured to be disposed with the multidirectional charging cradle, the multidirectional power unit including a second electrical contact having a first polarity and a plurality of third electrical contracts having a second polarity, the second electrical contact and the plurality of third electrical contacts configured to engage with the plurality of first electrical contacts of the multidirectional charging cradle.

In some aspects, the techniques described herein relate to a system, wherein the plurality of first electrical contacts includes a negative cradle contact and a positive cradle contact.

In some aspects, the techniques described herein relate to a system, wherein the second electrical contact is a positive unit contact and wherein the plurality of third electrical contacts includes a first negative unit contact and a second negative unit contact, the first negative unit contact, the second negative unit contact and the positive unit contact arranged such that when the multidirectional power unit is disposed within the multidirectional charging cradle the positive unit contact engages with the positive cradle contact and one of the first negative unit contact and the second negative unit contact engages with the negative cradle contact.

In some aspects, the techniques described herein relate to a system, wherein the second electrical contact is negative unit contact and wherein the plurality of third electrical contacts includes a first positive unit contact and a second positive unit contact, the first positive unit contact, the second positive unit contact and the negative unit contact arranged such that when the multidirectional power unit is disposed within the multidirectional charging cradle the negative unit contact engages with the negative cradle contact and one of the first positive unit contact and the second positive unit contact engages with the positive cradle contact.

In some aspects, the techniques described herein relate to a system including a user interface, the user interface configured to allow a user to engage with the kiosk.

In some aspects, the techniques described herein relate to a system wherein the kiosk is configured to dispense a fully charged multidirectional power unit in response to a request received from a user via the user interface.

In some aspects, the techniques described herein relate to a method for charging a multidirectional power unit, the method including: receiving a multidirectional power unit in a charging cradle, the charging unit including a first electrical contact having a first polarity and a plurality of second electrical contracts having a second polarity; aligning the first electrical contact and at least one electrical contact of the plurality of second electrical contacts with a plurality of unit electrical contacts of the multidirectional power unit; identifying, via a control unit of the charging cradle, which of the plurality of second electrical contacts are aligned with one or more unit electrical contacts of the plurality of unit electrical contacts; applying a voltage to the contacts of the plurality of second electrical contacts that are aligned with the one or more unit electrical contacts of the plurality of unit electrical contacts; and charging the multidirectional power unit.

In some aspects, the techniques described herein relate to a method, wherein the first electrical contact includes a positive electrical contact and wherein the plurality of second electrical contacts includes a first negative electrical contact and a second negative electrical contact.

In some aspects, the techniques described herein relate to a method wherein aligning the first electrical contact and at least one electrical contact of the plurality of second electrical contacts with a plurality of unit electrical contacts of the multidirectional power unit includes aligning the positive electrical contact with a positive unit contact of the plurality of unit electrical contacts and aligning one of the first negative electrical contact and the second negative electrical contact with a negative unit contact of the plurality of unit electrical contacts.

In some aspects, the techniques described herein relate to a method, wherein the first electrical contact includes a negative electrical contact and wherein the plurality of second electrical contacts includes a first positive electrical contact and a second positive contact.

In some aspects, the techniques described herein relate to a method, wherein aligning the first electrical contact and at least one electrical contact of the plurality of second electrical contacts with a plurality of unit electrical contacts of the multidirectional power unit includes aligning the negative electrical contact with a negative unit contact of the plurality of unit electrical contacts and aligning one of the first positive electrical contact and the second positive electrical contact with a positive unit contact of the plurality of unit electrical contacts.

In some aspects, the techniques described herein relate to a method further including neutralizing the contacts of the plurality of second electrical contacts that are not aligned with any electrical contacts of the plurality of unit electrical contacts. 21.

### BRIEF DESCRIPTION OF THE DRAWINGS

FIG. 1A is an exemplary diagram of a charging system comprising a number of multidirectional rechargeable power units and a corresponding kiosk for recharging and recirculating the multidirectional rechargeable power units.

FIG. 1B is an exemplary a system diagram depicting illustrative components of a charging system for multidirectional rechargeable power units.

FIG. 2 is an illustrative circuit diagram of a multidirectional charging cradle to recharge rechargeable power units with multidirectional charging pins.

FIG. 3A is a view of an embodiment of a rechargeable power unit with multidirectional charging pins in which the front side of the rechargeable power unit is visible and facing upwards.

FIG. 3B is a view of an embodiment of a rechargeable power unit with multidirectional charging pins in which the back side of the rechargeable power unit is visible and facing upwards.

FIG. 3C is a view of an embodiment of a rechargeable power unit with multidirectional charging pins in which the charging side of the rechargeable power unit is visible, including its multidirectional charging pins and a power button.

FIG. 3D is a view of an embodiment of a rechargeable power unit with multidirectional charging pins in which the charging side of the rechargeable power unit is visible, including its multidirectional charging pins and a series of indicator lights.

FIG. 3E is a view of a rechargeable power unit with multidirectional charging pins in which the charging side of the rechargeable power unit is visible, including its multidirectional charging pins and a series of indicator lights.

FIG. 4 is an exemplary diagram depicting illustrative steps involved in a multidirectional rechargeable power unit entering a charging system kiosk for recharge and subsequent recirculation.

FIG. 5 is an exemplary flow chart illustrating an exemplary method for charging a multidirectional rechargeable power unit in a way that is orientation-agnostic to the charging cradle of a kiosk.

### DETAILED DESCRIPTION

Generally described, aspects of the present disclosure relate to embodiments of a rechargeable power unit supporting multidirectional charging at a charging cradle. Also disclosed are multiple embodiments of a method of charging a rechargeable power unit comprising multidirectional charging pins at a charging cradle without regard to the orientation of the rechargeable power unit. Although certain embodiments of the present invention are shown and described in detail, it should be understood that various changes and modifications may be made without departing from the scope of the appended claims. The scope of the present application is in no way limited to the number of constituting components, the materials thereof, the quantities thereof, the relative arrangement thereof, etc.

For ease of description and illustration, the term “standard form factor” or its variants may be used. Typical cylindrical batteries such as AAA, AA, C and D may be described as having “standard form factors.” However, one of skill in the art will recognize that batteries of many shapes and sizes having less common form factors including 9V, prismatic batteries, or coin-shaped batteries may be comprising the features described herein without departing from the scope of the present disclosure. Also, it is contemplated that some embodiments may not include all of the recited materials, thus sub-combinations of the listed materials are contemplated.

Batteries power a variety of devices, and as more devices become battery powered, consumer reliance on batteries increases. For example, smartphones have become ubiquitous and a core part of daily life for many users. However, smartphones are limited by their battery life, which often deteriorates over the lifespan of the device. As technological advances continue to rapidly progress, users develop more and more of a reliance on the battery life of electronic devices for vital tasks such as navigation, workplace communication, photo and video capture, social connection, location sharing, and safety measures. However, user reliance on smartphones can backfire if the user finds themself in need of their smartphone while the smartphone battery is dead and no charging outlet is readily available (e.g., at an airport or a theme park). Thus, an ability to quickly and easily restore battery life for such devices becomes critical, especially in contexts when traditional charging solutions may not be readily available. For some users, a charged smartphone battery could be the difference between life or death in an emergency situation.

One solution for providing an easily rechargeable power unit involves a network of kiosks that operate much like vending machines for power units. The kiosks allow a user to trade a rechargeable power unit with no remaining battery life into the kiosk in exchange for a new, freshly charged power unit. For example, a user charging their smartphone with a rechargeable power unit at an airport may discover that their rechargeable power unit ran out of battery life and can no longer charge their smartphone. In dire need of battery life for their smartphone in order to watch a movie on their flight, this user could go to a compatible kiosk at the airport, deposit their dead rechargeable power unit into the kiosk, and receive a new rechargeable power unit from the kiosk in return. In this way, such a user could use the new rechargeable power unit from the kiosk to continue charging their smartphone for the duration of their travel journey.

A network of kiosks for rechargeable power units becomes a powerful solution for many users, especially in contexts in which traditional charging solutions such as wall outlets may not be available. All the while, this network of kiosks also creates a sharing economy for rechargeable power units that reduces waste and allows many users share access to and rotate through the power units being charged in the kiosks as the need arises. Because such a network of kiosks provides a powerful, affordable, and easily accessible solution to many users of battery powered devices, a need arises to optimize the operation of such kiosks. As kiosk function and operation is optimized, the cost to the end user decreases and the experience of receiving a freshly charged power unit becomes more seamless.

Rechargeable power units are often connected to a smartphone via a wired connection via a standard connector, such as USB or USB-C. Rechargeable power units can be charged via a wired connection as well. Charging a large volume of rechargeable power units using wired connections, which involve plugging in a charging cord within a kiosk would be labor intensive, requiring human interaction or sophisticated or complicated robotics.

Some rechargeable power units are charged using contacts, but these are unidirectional, meaning that such rechargeable power units can only receive a charge when aligned in the correct direction with the charging cradle. Specifically, the positive pin and the negative pin of the power unit must align in the correct direction with their respective counterparts in the charging cradle or charging receptacle. This limitation can create complications in the context of an automated kiosk containing a charging cradle for rechargeable power units. Automated kiosks for rechargeable power units may rely on robotics to receive, recharge, and redistribute power units to users. In some embodiments, the kiosk relies on a user to insert a rechargeable power unit into a charging slot in or near the kiosk. A user may not insert a rechargeable power unit correctly or in the proper orientation to allow for charging. If the rechargeable power unit is not in the correct orientation, it cannot automatically be charged without intervention, such as by robotics. Robotics able to correctly align the positive and negative pins of a rechargeable power unit with the cradle before recharging the power unit increase complexity, create room for error, increases operational costs as well as additional costs in development of sophisticated robotics. Thus, a user would be at risk for receiving a supposedly “charged” power unit that did not, in fact, charge properly while in the kiosk due to a robotics error in the alignment of the power unit with the charging cradle. Further, costs to develop such kiosks increase by orders of magnitude as the sophistication required by the internal robotics of the kiosk increases. This increased cost of each kiosk will mean that there will be less resources available to build a wide network of available kiosks, and further, some of these costs may end up being passed along to the users of the power units—an undesirable outcome for users seeking an affordable and accessible solution for their battery charging needs.

Given the details described above, the present disclosure is directed towards optimizing the way rechargeable power units are recharged in the context of the aforementioned kiosk or other related charging cradles. Namely, the present disclosure relates to embodiments of a rechargeable power unit supporting multidirectional charging at a charging cradle (e.g., a kiosk). A rechargeable power unit supporting multidirectional charging allows the power unit to correctly charge from a variety of different alignments and positions within the charging cradle due to the versatility of its design. Specifically, by strategically placing the positive and negative pins of the power unit in a multidirectional design, the power unit may charge correctly without concern as to its alignment with the charging cradle (e.g., within a kiosk implementing robotic automation). The multidirectional placement of pins on a rechargeable power unit will be described at length in the discussion that follows.

To allow for the flexible, affordable, and accessible recharging of power units in charging cradles (e.g., charging cradles found in a kiosk), systems and methods described herein provide for rechargeable power units that support orientation-agnostic charging through use of multidirectional charging pins. In this way, the present disclosure represents a technological improvement on battery systems, vending kiosks, and rechargeable power units, which allows for new, innovative, and flexible modes of recharging power units that were not possible before. What is more, the present solution meets a consumer need, allowing users to safely and affordably rely on their devices such as smartphones, even when the device battery life runs low and traditional charging options are not available. These concepts and others will be described in greater detail in the following paragraphs.

Within this disclosure, reference is made to the accompanying drawings, which form a part hereof. In the drawings, similar symbols typically identify similar components, unless context dictates otherwise. The illustrative embodiments described in the detailed description and drawings are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

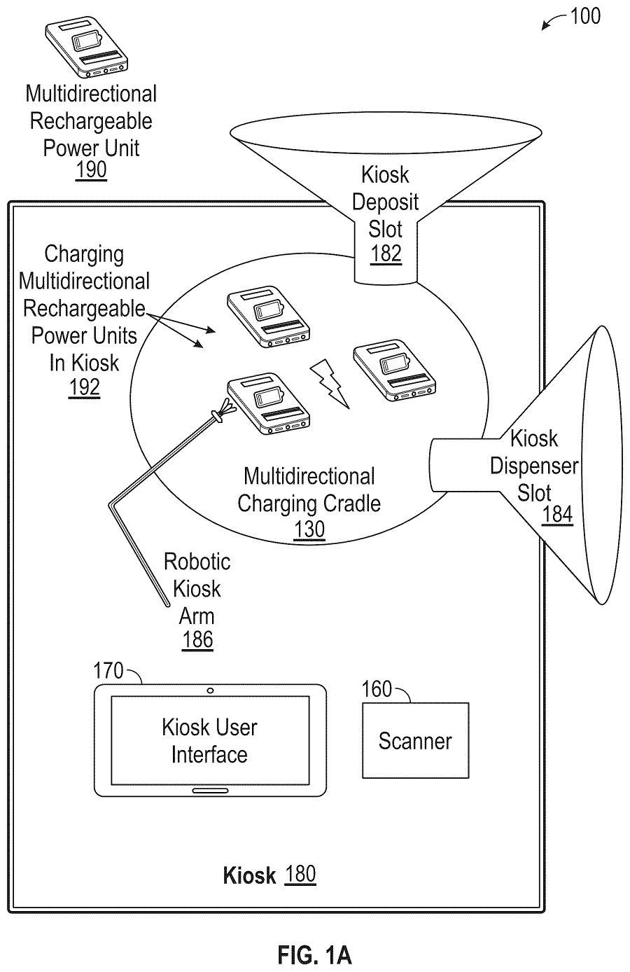

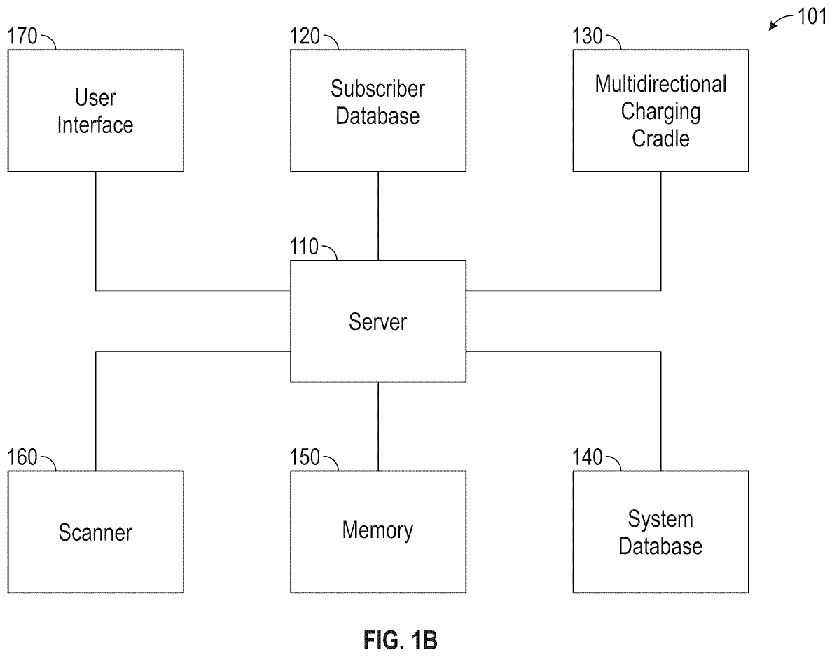

FIG. 1A depicts an exemplary diagram of a charging system comprising a number of multidirectional rechargeable power units and a corresponding kiosk for recharging and recirculating the multidirectional rechargeable power units. In some embodiments, the charging system 100 charges a multidirectional rechargeable power unit 190 with the orientation-agnostic charging design found in a kiosk 180. The kiosk 180 may illustratively comprise a variety of sub-components, including a scanner 160, a kiosk user interface 170, a kiosk deposit slot 182, a multidirectional charging cradle 130 for storing and charging any number of multidirectional rechargeable power units 192, a robotic kiosk arm 186 for manipulation of the multidirectional rechargeable power units 192, a kiosk dispenser slot 184 to release and recirculate a fully charged multidirectional rechargeable power unit from the charging cradle 130 to a user. The multidirectional charging cradle 130 comprises a physical port for the rechargeable power unit 190 to be charged. In some embodiments the physical port may include a Micro-USB, Type A charger, Type B charger, USB Type C Cable. In some embodiments, the port can be a wireless communication interface, such as Bluetooth® or the like.

The kiosk user interface 170 allows a user to interface with the charging system 100. The user interface 170 may be embodied in a kiosk with a graphical interface, a touch screen, soft keys or buttons, and the like. In some embodiments, the charging system 100 can be within a kiosk used for vending and receiving rechargeable power units. In some embodiments, the user interface 170 is the point of contact with the charging system of rechargeable power units. The user interface 170 may include varying options for the user to input information about the rechargeable power unit. In some embodiments, the user interface 170 may prompt a user for a barcode associated with the rechargeable power unit in order to identify the rechargeable power unit 190 or identify a type of the multidirectional rechargeable power unit 190. The scanner 160 may be used to scan barcodes or other identifying information on the rechargeable power unit 190 prior to deposit of the rechargeable power unit 190 into the kiosk 180 through the kiosk deposit slot 182. In some embodiments, the user interface 170 and the charging system can be used or operated by a technician or a customer.

In some embodiments, the multidirectional charging cradle 130 is a subsection of the kiosk 180 that contains multidirectional charging slots for any number of multidirectional charging units 192 that are presently charging within the kiosk 180. In some embodiments, the robotic kiosk arm 186 may place a multidirectional power unit 190 in need of a charge within the multidirectional charging cradle 130 upon the submission of the multidirectional power unit 190 into the kiosk deposit slot 182. In an alternative embodiment, the kiosk deposit slot 182 may drop the multidirectional rechargeable power unit 190 directly into the multidirectional charging cradle 130, making use of gravity to allow the multidirectional rechargeable power unit 190 to fall into the next available slot within the multidirectional charging cradle 130. In another embodiment, the kiosk 180 and the multidirectional charging cradle 130 may be operable by a human operator that manually places any number of deposited multidirectional rechargeable power units 192 from a holding container (not pictured) within the kiosk 180 into the multidirectional charging cradle 130. In such an embodiment, the multidirectional charging cradle 130 may exist outside of the kiosk 180 entirely. In some embodiments, the kiosk 180 may require a user to insert a spent multidirectional rechargeable power unit 190 or a multidirectional rechargeable power unit 190 which the user wishes to exchange into a charging port in the kiosk 180. The kiosk 180 may open a single compartment to allow access to a single charging cradle 130. The multidirectional charging cradle 130 will detect when the multidirectional rechargeable power units 192 is inserted, and only then allow access to a separate compartment for the user to retrieve a charged multidirectional rechargeable power unit 190 or vend a charged multidirectional rechargeable power unit 190.

In some embodiments, once the charging multidirectional rechargeable units in the kiosk 192 have received a full charge within the multidirectional charging cradle 130, the robotic arm 186 may prepare them to exit the kiosk 180 for recirculation. The robotic arm 186 may place the fully charged multidirectional rechargeable units 192 into the kiosk dispenser slot 184 in response to a user requesting a new, fully charged multidirectional rechargeable unit 192. In some embodiments, the kiosk 180 may not include a robotic kiosk arm 186 but may use mechanisms, gravity, and the like to receive and vend multidirectional rechargeable power units 190. In some embodiments, this user may drop off a multidirectional rechargeable power unit 190 into the kiosk 180 and in exchange receive the new, fully charged multidirectional rechargeable unit 192 for further use in powering their personal devices. In some embodiments, the kiosk may exist in a public area such as an airport, theme park, shopping center, or transportation station for easy access by users in need of a new, fully charged multidirectional rechargeable unit 192. In some embodiments, the kiosk 180 may request and receive payment from a user at the user interface 170.

FIG. 1B is an exemplary a system diagram depicting illustrative components of a charging system 101 for a multidirectional rechargeable power unit 190. In some embodiments, the components of the charging system 101 may operate within the context of a kiosk 180, as described in FIG. 1A. The charging system 101 may include components such as a server 110, a subscriber database 120, a multidirectional charging cradle 130, a system database 140, a memory 150, a scanner 160, and a user interface 170.

The server 110 comprises one or more processors or similar data processing components or circuits that are able to receive information from the other parts of the charging system 101 and process them in a fashion that allows for the orientation-agnostic charging of rechargeable power units 190. The server 110 is in communication with the other components of the charging system 101 such as the subscriber database 120, the multidirectional charging cradle 130, the system database 140, the memory 150, the scanner 160, and the user interface 170. In some embodiments, the server 110 connects a multidirectional rechargeable power unit 190 to the multidirectional charging cradle 130 via a wired or wireless connection. When a connection is made between the multidirectional rechargeable power unit 190 and the server 110, the server 110 can run diagnostic programs on the multidirectional rechargeable power unit 190 to determine the health and/or repair needs of the multidirectional rechargeable power unit 190. In some embodiments, the server 110 may also make updates to the subscriber database 120 and the system database 140 in relation to its present connection to the multidirectional rechargeable power unit 190.

The subscriber database 120 stores information of all user subscription data that the charging system 101 may need to store. In some embodiments, the subscriber database 120 includes, but is not limited to, names, phone numbers, email addresses, physical address, payment information, serial numbers or identifiers of multidirectional rechargeable power units 190 held or associated with a subscriber, etc.

The system database 140 comprises a list of multidirectional rechargeable power units 190 that have been bought, borrowed, vended, etc., a list of the amount of charges and/or discharges each multidirectional rechargeable power unit 190 has undergone, unique identifiers of multidirectional rechargeable power units 190, the quantity of multidirectional rechargeable power units 190 that the current charging system 101 has in stock, the number of times a multidirectional rechargeable power unit 190 has been vended and/or returned, the number of times a multidirectional rechargeable power unit 190 has been returned for broken parts, etc.

The kiosk memory 150 stores information received from the other components such as the server 110, the scanner 160, and the user interface 170. The kiosk memory 150 can store program information, algorithms, diagnostic programs, instructions for execution by the server 110, and the like.

The scanner 160 scans information provided by the user. In some embodiments, the scanner 160 may scan a barcode on a multidirectional rechargeable power unit 190 and populate information for the specific multidirectional rechargeable power unit 190 available on the user interface 170. The scanner 160 may also be provided with other information such as a unit number, part number, or troubleshoot ticket that it can scan and populate information regarding the multidirectional rechargeable power unit 190.

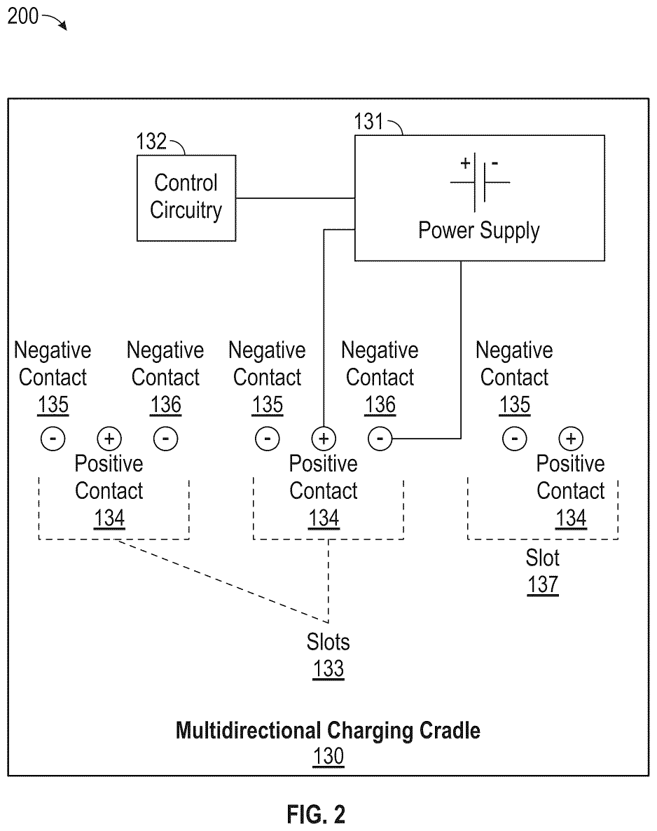

FIG. 2 is an illustrative circuit diagram 200 of a multidirectional charging cradle 130 that may be used to recharge multidirectional rechargeable power units 190. The multidirectional charging cradle 130 comprises a power supply 131, control circuitry 132, and any number of slots 133 able to hold multidirectional rechargeable power units 190 as they charge within the multidirectional charging cradle 130. The power supply 131 provides electricity to charge the multidirectional rechargeable power units 190 inserted into the slots 133. Although FIG. 2 only depicts electrical connections from the power supply 131 to one of the slots, it is understood that each slot 133 will be in electrical connection with the power supply 131. Each slot 133 in the multidirectional charging cradle 130 supports multidirectional charging through the arrangement of the positive contact 134 and the negative contact 135 and the negative contact 136. Notably, a multidirectional power unit 190 charging in a slot 133 may enter the slot with its positive and negative pins facing either direction and still be properly aligned with the contacts 134, 135, and 136 of the slot 133 in the multidirectional charging cradle 130. This is because the control circuitry 132 of the multidirectional charging cradle 130 may choose to apply a negative voltage to either negative contact 135 or negative contact 136 while applying a positive voltage to positive contact 134. In this way, the slots 133 of the multidirectional charging cradle 130 are agnostic to the orientation by which a multidirectional rechargeable power unit 190 is placed into the slot 133: the control circuitry 132 connects the multidirectional rechargeable power unit 190 to the power supply 131, creating a flow path. Notably, the flow path will never include both the negative contact 135 and the negative contact 136 within the same slot 133, rather, the control circuitry will always choose one negative contact (e.g., negative contact 136) for the flow path while neutralizing the other negative contact (e.g., negative contact 135) so that it is not involved in the circuit charging the multidirectional power unit 190.

In some embodiments, the multidirectional charging cradle 130 may include slots as pictured in slot 137 comprising one negative contact 135 and one positive contact 134. Notably, a multidirectional power unit 190 charging in a slot 137 may enter the slot with its positive and negative pins facing either direction and still be properly aligned with the contacts 134 and 135 of the slot 137 in the multidirectional charging cradle 130. This is because the multidirectional power unit 190 comprises negative multidirectional pins on either side of its port as well as a positive multidirectional pin, and either negative multidirectional pin may align with the two contacts in slot 137, as will be described in greater detail below. In some embodiments, a multidirectional power unit 190 may comprise two positive multidirectional pins and one negative multidirectional pin, providing the same flexibility at slot 137 in which the multidirectional power unit 190 may enter slot 137 with its positive and negative pins facing either direction. One of skill in the art will understand that the slots 133 and the multidirectional rechargeable power unit 190 will have corresponding arraignment of positive and negative contacts. That is, if the rechargeable power unit 190 has a central positive terminal and a negative terminal spaced apart from the central positive terminal, the slot will have a corresponding arrangement of positive and negative terminals. Similarly, a multidirectional rechargeable power unit 190 may have a central negative terminal and a positive terminal spaced apart from the central negative terminal. A corresponding charging slot will have the complementary arrangement of negative and positive charging terminals such that the multidirectional rechargeable power unit 190 will charge regardless of the orientation in which the multidirectional rechargeable power unit 190 is inserted into the slot 133.

In some embodiments, the slots 133 may comprise a more negative or positive contacts, as one of skill in the art would understand, arranged at distances or locations corresponding to the locations of charging ports or terminals on a multidirectional rechargeable power unit 190. That is, the slots may be configured to receive different types or form factors of a multidirectional rechargeable power unit 190, and thus there will be at least one positive and one negative contact located in the slot 133 such that connection can be made with the multidirectional rechargeable power unit 190.

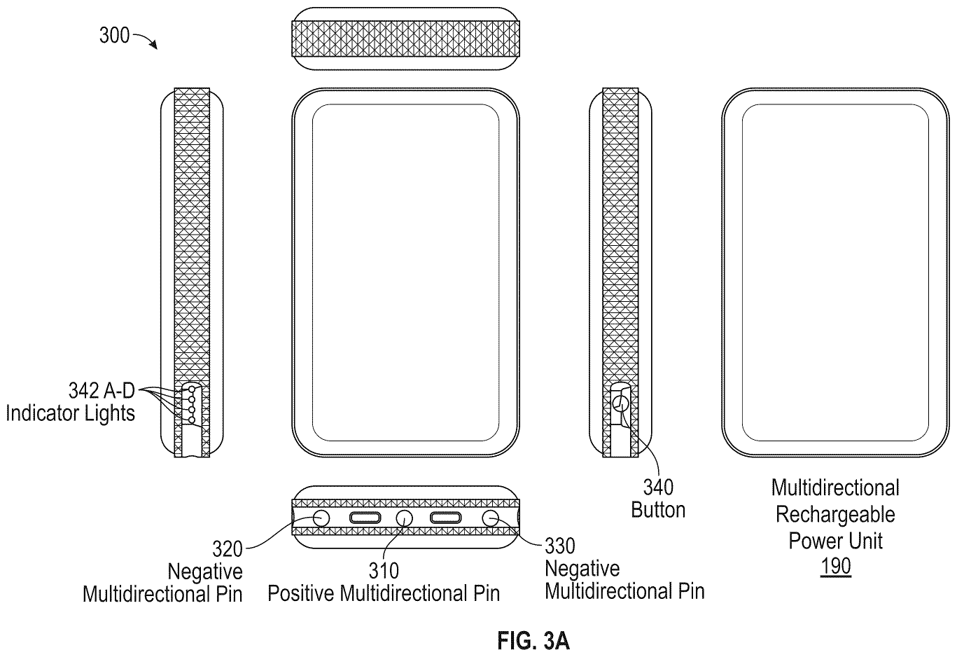

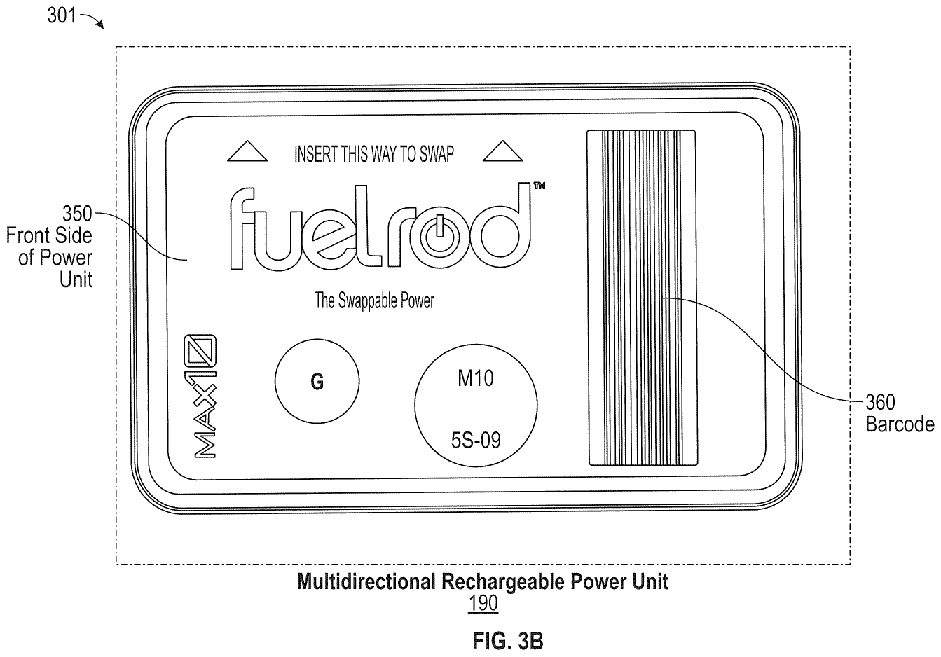

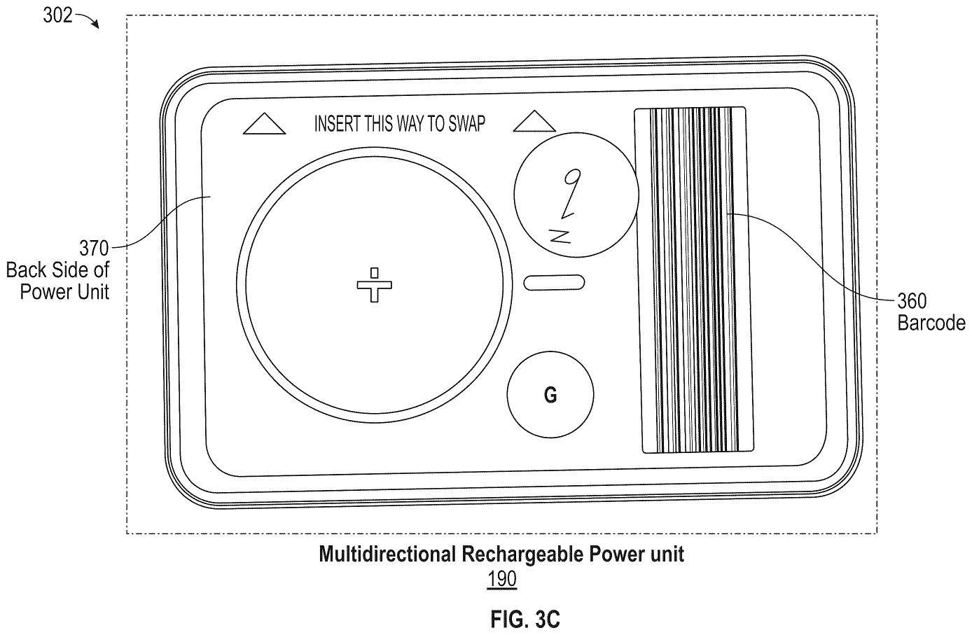

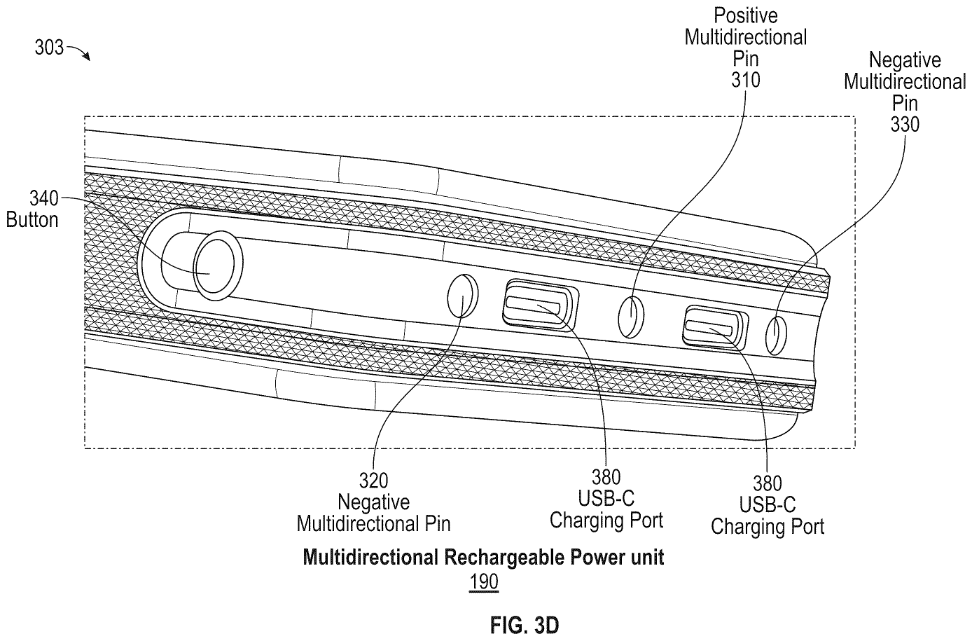

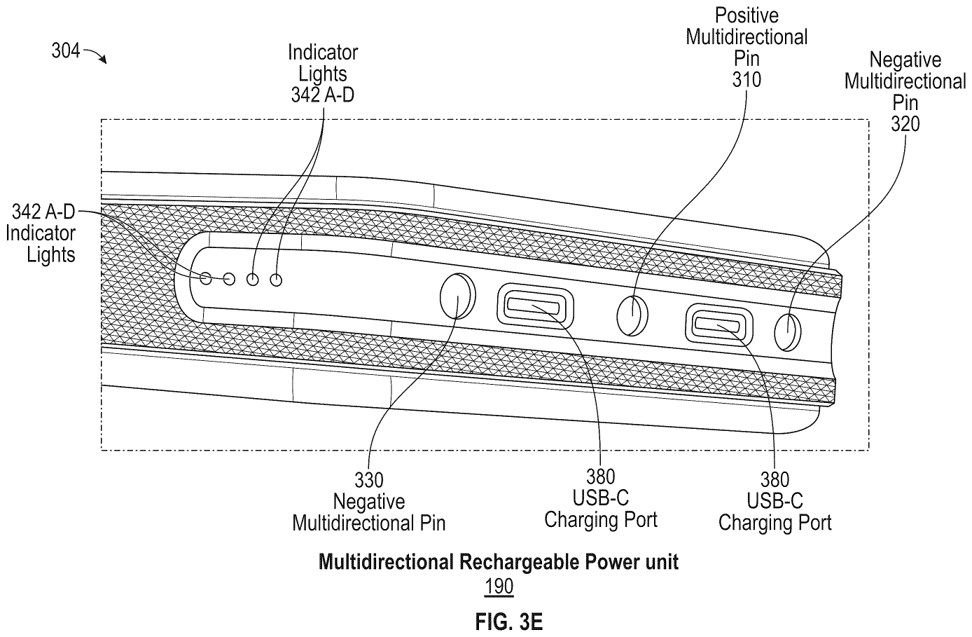

FIG. 3A depicts a series of views of an embodiment 300 of a multidirectional rechargeable power unit 190 with multidirectional charging pins that may align agnostically with the multidirectional charging cradle 130. The rechargeable power unit 190 includes negative multidirectional pins 320 and 330, positive multidirectional pin 310, a button 340, and one or more lights 342 A-D. The button 340 can serve as a power on/off function. In some embodiments, the button 340 serves as a check on the charge level of the rechargeable power unit 190. In some embodiments, the lights 342 A-D also serve to show the charge level of the rechargeable power unit 190. In some embodiments, the user can push the button 340, and depending on the charge level of the rechargeable power unit 190, any number of lights 342 A-D (or none at all) may blink, with more lights meaning more charge and less lights meaning less charge.

The arrangement of the pins on the multidirectional rechargeable power unit 190 allows for its agnostic orientation in a slot 137 of a multidirectional charging cradle 130, which has only a single positive contact 134 and one negative contact 135. regardless of which way the multidirectional rechargeable power unit 190 is inserted into the slot 137, with the positive multidirectional pin 310 will align with the positive contact 134 and the negative contact 135 will align with either the negative multidirectional pin 320 or the negative multidirectional pin 330. In this way, the control circuity 132 between the multidirectional rechargeable power unit 190 via positive contact 134 and negative contact 135, and commences a charging program.

In another example, the multidirectional rechargeable power unit 190 may be placed in the slot 133 with negative multidirectional pin 320 aligned with negative contact 136, positive multidirectional pin 310 aligned with positive contact 134, and negative multidirectional pin 330 aligned with negative contact 135. The control circuity 132 can detect electrical contact between the positive contact 134 and the positive multidirectional pin 310 and between the negative contact 135 and one of the negative multidirectional pin 320 or 330, and between the negative contact 136 and the other of negative multidirectional pin 320 or negative multidirectional pin 330. The control circuitry 132 makes a determination of which of negative contact 135 and negative contact 136 to use to apply a charging current to the multidirectional rechargeable power unit 190.

In either example, the control circuitry 132 of the multidirectional charging cradle 130 will choose to create a flow path through one of the negative contacts (either negative contact 135 or negative contact 136) while neutralizing the negative contact not chosen. In this way, embodiments of a kiosk 180 that make use of a robotic kiosk arm 186 do not have to program the robotic kiosk arm to do the complicated task of arranging a power unit at exactly the right alignment to match a single positive and negative contact of the slot 133 (or alternatively, find the precise alignment for a more complicated USB-C connection to the power source). Instead of either of these programming-intensive operations for the robotic arm 186, the multidirectional charging cradle 130 provides flexibility to the robotic arm 186, or to another mechanism, such as a mechanical slot, gravity, or a user, allowing it to place multidirectional rechargeable power units 190 into the slot without regard to the orientation of the contacts in the slot 133 and the pins on the multidirectional rechargeable power unit 190. In some embodiments, the multidirectional rechargeable power unit 190 is a lithium ion battery. The input voltage may range from 5 volts direct current (VDC) to 12 VDC.

In some embodiments, in which no robotic kiosk arm 186 is present within the kiosk, the multidirectional charging cradle 130 still provides flexibility by allowing a multidirectional rechargeable power units 190 to fall into the slot 133 from a the kiosk deposit slot 182 without regard to the orientation of the contacts in the slot 133 and the pins on the multidirectional rechargeable power unit 190 and without relying on a user to correctly align the multidirectional rechargeable power unit 190 when placing it in the kiosk.

FIG. 3B is a view of an embodiment 301 of a multidirectional rechargeable power unit 190 with multidirectional charging pins in which the front side of the rechargeable power unit is visible and facing upwards. The front side of the power unit 350 may display a barcode 360 that can be used by technology such as the scanner 160 to identify a type of or a unique multidirectional rechargeable power unit 190. For example, reading the barcode 360, the control circuitry 132 can determine the form factor or type of multidirectional rechargeable power unit 190 being returned or inserted, and can route the multidirectional rechargeable power unit 190 within the kiosk to the appropriate charging port. The scanner 160 can also identify a subscriber or user, including a user account, based on the scan of the barcode 360.

FIG. 3C is a view of an embodiment 302 of a rechargeable power unit 190 with multidirectional charging pins in which the back side of the rechargeable power unit is visible and facing upwards. The back side of the power unit 370 may display a barcode 360 that can be used by technology such as the scanner 160 to identify a unique multidirectional rechargeable power unit 190. The back side of the power unit 370 may also allow for wireless or other cordless methods of recharging the multidirectional rechargeable power unit 190 outside of a charging cradle.

FIG. 3D is a view of an embodiment 303 of a rechargeable power unit 190 with multidirectional charging pins in which the charging side of the rechargeable power unit 190 is visible, including its multidirectional charging pins and a power button 340. The charging side of the rechargeable power unit 190 includes positive multidirectional pin 310, negative multidirectional pin 320, and negative multidirectional pin 330. The charging side of the rechargeable power unit 190 may also include USB-C charging ports 380 that serve as a power-out source when a user charges a personal electronic device (e.g., a smartphone) with the rechargeable power unit 190. The power button 340 along the side of the rechargeable power unit 190 powers the rechargeable power unit 190 on and off.

FIG. 3E is a view of an embodiment 304 of a rechargeable power unit 190 with multidirectional charging pins in which the charging side of the rechargeable power unit 190 is visible, including its multidirectional charging pins and a series of indicator lights 342 A-D. The charging side of the rechargeable power unit 190 includes positive multidirectional pin 310, negative multidirectional pin 320, and negative multidirectional pin 330. The charging side of the rechargeable power unit 190 may also include USB-C charging ports 380 that serve as a power-out source when a user charges a personal electronic device (e.g., a smartphone) with the rechargeable power unit 190. In some embodiments, the lights 342 A-D serve to show the charge level of the rechargeable power unit 190. In some embodiments, the user can push the button 340, and depending on the charge level of the rechargeable power unit 190, any number of lights 342 A-D (or none at all) may blink, with more lights meaning more charge and less lights meaning less charge.

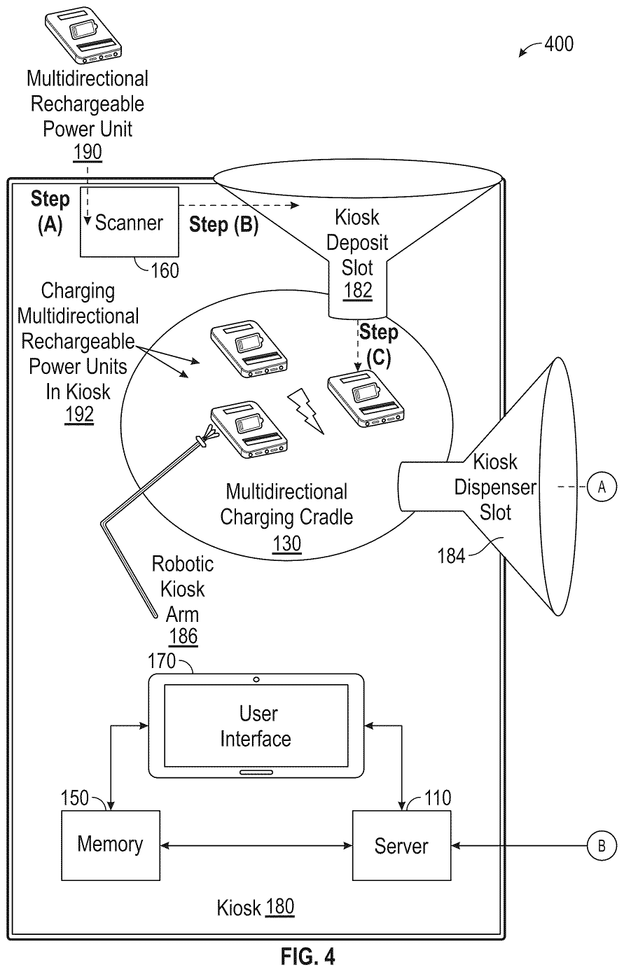

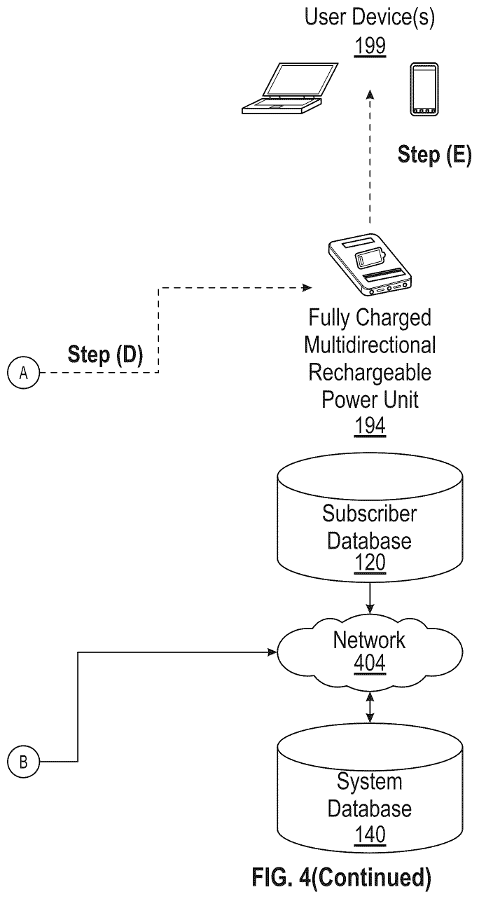

FIG. 4 is an exemplary diagram depicting illustrative steps involved in a multidirectional rechargeable power unit 190 entering a charging system kiosk 180 for recharge and subsequent recirculation. In some embodiments, a multidirectional rechargeable power unit 190 may require recharging due to a low battery. A user may thus decide to swap out the multidirectional rechargeable power unit 190 with a low battery at a nearby kiosk 180 for a fully charged replacement multidirectional rechargeable power unit 194. To do so, a user may begin at Step (A) by scanning the barcode 360 located on the front side 350 or the back side 370 of the multidirectional rechargeable power unit 194 with the scanner 160 of the kiosk 180. The user may also make use of the user interface 170 of the kiosk 180 during Step (A) to make further selections, provide payment, or input other additional information about the transaction before proceeding to Step (B). Interactions at the user interface 170 may be processed by the server 110, which makes use of the memory 150 as well as the subscriber database 120 and the system database 140 (which it may connect to over a network 404) to process and gather relevant data for each transaction at the kiosk.

At Step (B), the user may input the multidirectional rechargeable power unit 190 with a low battery into the kiosk deposit slot 182. At Step (C), in some embodiments, a robotic kiosk arm 186 may then transport the deposited multidirectional rechargeable power unit 190 into a slot 133 of the multidirectional charging cradle 130. As previously discussed, the deposited power unit 190 may be placed into slot 133 of the multidirectional charging cradle 130 without regard to the orientation of its positive contact pin 310 and its negative contact pins 320 and 330. In some embodiments of Step (C), the kiosk deposit slot 182 drops a deposited multidirectional rechargeable power unit 190 without use of a robotic kiosk arm 186, instead relying on gravity and/or other mechanical mechanism, and the multidirectionality of the charging cradle 130 and deposited power unit 190 to drop the deposited power unit 190 into the next available slot 133. Notably, the multidirectional charging cradle may house any number of currently charging multidirectional rechargeable power units 192 in its slots 133. These multidirectional rechargeable power units 192 eventually complete their recharge within the multidirectional charging cradle 130, at which point they are ready to be output and recirculated to a user at Step (D). In some embodiments, the robotic kiosk arm 186 may transfer the fully charged multidirectional rechargeable power unit 194 out through the kiosk dispenser slot, and in other embodiments, the fully charged multidirectional rechargeable power unit 194 may dispense without use of a robotic kiosk arm 186. Upon receiving a fully charged multidirectional rechargeable power unit 194 at Step (E), the user may resume charging their user devices 199 with the fully charged multidirectional rechargeable power unit 194.

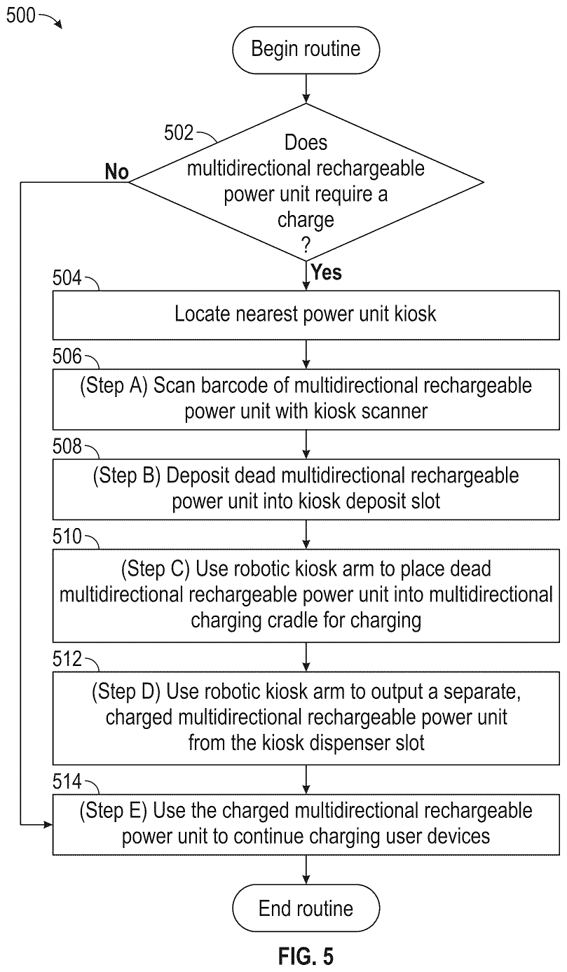

FIG. 5 is an exemplary flow chart illustrating an exemplary method 500 for charging a multidirectional rechargeable power unit in a way that is orientation-agnostic to the charging cradle of a kiosk. The steps marked by letters “A” “E” within method 500 correspond to the same steps of the same name discussed in FIG. 4. Routine 500 begins at decision block 502 in which a determination is made as to whether the multidirectional rechargeable power unit 190 requires a charge due to low battery. If the answer to decision block 502 is no, the routine skips to block 514 in which the charged multidirectional rechargeable power unit continues to charge user devices 199. If the answer to decision block 502 is yes, the routine proceeds to block 504, in which the nearest power unit kiosk 180 is located. Next, the routine proceeds to block 506 “(Step A)” in which the barcode 360 of the multidirectional rechargeable power unit 190 is scanned with kiosk scanner 160. Next, the routine proceeds to block 508 “(Step B)” to deposit the dead multidirectional rechargeable power unit 190 into kiosk deposit slot 182. Next, in some embodiments, the routine proceeds to block 510 “(Step C)” to use the robotic kiosk arm 186 to place dead multidirectional rechargeable power unit 190 into multidirectional charging cradle 130 for charging. In some embodiments, the kiosk may use another mechanism, not a robotic arm, to direct the multidirectional rechargeable power unit 190 to a slot 133. With the multidirectional rechargeable power unit 190 in a slot 133, the control circuitry, including one or more processors, detects which terminals of the multidirectional rechargeable power unit 190 are in electrical contact with the contacts of the slot 133, and the one or more processors cause charging to commence using the terminals of the slot 133 which are in electrical communication with the terminals of the multidirectional rechargeable power unit 190. As noted above, the multidirectional rechargeable power unit 190 may comprise one positive terminal and one negative terminal, and the slot 133 comprises a positive terminal and two negative terminals. In some embodiments, the multidirectional rechargeable power unit 190 may comprise one positive connection and two negative connections, and the slot 137 comprises one positive and one negative terminal. In either arrangement, charging can occur, regardless of the orientation of the multidirectional rechargeable power unit 190 in the slot 133 or slot 137.

Next the routine proceeds to block 512, “(Step D)”, in which the robotic kiosk arm 186, or other mechanism, outputs a charged multidirectional rechargeable power unit 194 from the kiosk dispenser slot 184. Finally at block 514, “(Step E),” the charged multidirectional rechargeable power unit 194 may be used to continue charging user devices 199.

The technology is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, processor-based systems, programmable consumer electronics, network PCs, minicomputers, mainframe computers, distributed computing environments that include any of the above systems or devices, and the like.

As used herein, instructions refer to computer-implemented steps for processing information in the system. Instructions can be implemented in software, firmware or hardware and include any type of programmed step undertaken by components of the system.

A processor may be any conventional general purpose single-or multi-chip processor such as a Pentium® processor, a Pentium® Pro processor, a 8051 processor, a MIPS® processor, a Power PC® processor, or an Alpha® processor. In addition, the processor may be any conventional special purpose processor such as a digital signal processor or a graphics processor. The processor typically has conventional address lines, conventional data lines, and one or more conventional control lines.

The system is comprised of various modules as discussed in detail. As can be appreciated by one of ordinary skill in the art, each of the modules comprises various sub-routines, procedures, definitional statements and macros. Each of the modules are typically separately compiled and linked into a single executable program. Therefore, the description of each of the modules is used for convenience to describe the functionality of the preferred system. Thus, the processes that are undergone by each of the modules may be arbitrarily redistributed to one of the other modules, combined together in a single module, or made available in, for example, a shareable dynamic link library.

The system may be used in connection with various operating systems such as Linux®, UNIX® or Microsoft Windows®.

The system may be written in any conventional programming language such as C, C++, BASIC, Pascal, or Java, and ran under a conventional operating system. C, C++, BASIC, Pascal, Java, and FORTRAN are industry standard programming languages for which many commercial compilers can be used to create executable code. The system may also be written using interpreted languages such as Perl, Python or Ruby.

Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

In one or more example embodiments, the functions and methods described may be implemented in hardware, software, or firmware executed on a processor, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting.

What is claimed is:

1. A charging system comprising:
a multidirectional charging cradle configured to receive one or more rechargeable power units, the multidirectional charging cradle comprising a first electrical contact configured to have a first polarity, and a plurality of second electrical contacts configured to have a second polarity; and
a control unit in communication with the multidirectional charging cradle, the control unit configured to apply voltages to the first electrical contact and one of the plurality of second electrical contacts based on an orientation of a rechargeable power unit disposed within the multidirectional charging cradle.

2. The system of claim 1, wherein the multidirectional charging cradle comprises a plurality of slots, each slot of the plurality of slots configured to accept a rechargeable power unit.

3. The system of claim 1, wherein the first electrical contact configured to have the first polarity is a positive polarity contact, and wherein the plurality of second contacts configured to have a second polarity comprises a first negative contact and a second negative contact.

4. The system of claim 3, wherein the first negative contact and the second negative contact are arranged opposite to one other on either side of the positive polarity contact.

5. The multidirectional power unit kiosk of claim 3, wherein the control unit is configured to identify which of the first negative contact and the second negative contact is in electrical connection with a negative terminal of the rechargeable power unit, and to apply a negative voltage to the identified one of the first negative contact and the second negative contact.

6. The multidirectional power unit kiosk of claim 3, wherein the control unit is configured to identify an orientation of a rechargeable power unit and apply a voltage to one of the first negative contact and the second negative contact that is engaged with a negative electrical contact of the rechargeable power unit.

7. The multidirectional power unit kiosk of claim 3, wherein the control unit is configured to identify an orientation of a rechargeable power unit and neutralize one of the first negative contact and the second negative contact that is not engaged with a negative electrical contact of the rechargeable power unit.

8. The multidirectional power unit kiosk of claim 1, wherein the control unit is configured to run diagnostic programs on rechargeable power units to determine battery health prior to charging.

9. A system for charging rechargeable power units, the system comprising:
a kiosk comprising a multidirectional charging cradle configured to receive one or more rechargeable power units, the multidirectional charging cradle comprising a plurality of first electrical contacts; and
a multidirectional power unit configured to be disposed with the multidirectional charging cradle, the multidirectional power unit comprising a second electrical contact having a first polarity and a plurality of third electrical contracts having a second polarity, the second electrical contact and the plurality of third electrical contacts configured to engage with the plurality of first electrical contacts of the multidirectional charging cradle.

10. The system of claim 9, wherein the plurality of first electrical contacts comprises a negative cradle contact and a positive cradle contact.

11. The system of claim 10, wherein the second electrical contact is a positive unit contact and wherein the plurality of third electrical contacts comprises a first negative unit contact and a second negative unit contact, the first negative unit contact, the second negative unit contact and the positive unit contact arranged such that when the multidirectional power unit is disposed within the multidirectional charging cradle the positive unit contact engages with the positive cradle contact and one of the first negative unit contact and the second negative unit contact engages with the negative cradle contact.

12. The system of claim 10, wherein the second electrical contact is negative unit contact and wherein the plurality of third electrical contacts comprises a first positive unit contact and a second positive unit contact, the first positive unit contact, the second positive unit contact and the negative unit contact arranged such that when the multidirectional power unit is disposed within the multidirectional charging cradle the negative unit contact engages with the negative cradle contact and one of the first positive unit contact and the second positive unit contact engages with the positive cradle contact.

13. The system of claim 9 comprising a user interface, the user interface configured to allow a user to engage with the kiosk.

14. The system of claim 13 wherein the kiosk is configured to dispense a fully charged multidirectional power unit in response to a request received from a user via the user interface.

15. A method for charging a multidirectional power unit, the method comprising:
receiving a multidirectional power unit in a charging cradle, the charging unit comprising a first electrical contact having a first polarity and a plurality of second electrical contracts having a second polarity;
aligning the first electrical contact and at least one electrical contact of the plurality of second electrical contacts with a plurality of unit electrical contacts of the multidirectional power unit;
identifying, via a control unit of the charging cradle, which of the plurality of second electrical contacts are aligned with one or more unit electrical contacts of the plurality of unit electrical contacts;
applying a voltage to the contacts of the plurality of second electrical contacts that are aligned with the one or more unit electrical contacts of the plurality of unit electrical contacts; and
charging the multidirectional power unit.

16. The method of claim 15, wherein the first electrical contact comprises a positive electrical contact and wherein the plurality of second electrical contacts comprises a first negative electrical contact and a second negative electrical contact.

17. The method of claim 16 wherein aligning the first electrical contact and at least one electrical contact of the plurality of second electrical contacts with a plurality of unit electrical contacts of the multidirectional power unit comprises aligning the positive electrical contact with a positive unit contact of the plurality of unit electrical contacts and aligning one of the first negative electrical contact and the second negative electrical contact with a negative unit contact of the plurality of unit electrical contacts.

18. The method of claim 15, wherein the first electrical contact comprises a negative electrical contact and wherein the plurality of second electrical contacts comprises a first positive electrical contact and a second positive contact.

19. The method of claim 18, wherein aligning the first electrical contact and at least one electrical contact of the plurality of second electrical contacts with a plurality of unit electrical contacts of the multidirectional power unit comprises aligning the negative electrical contact with a negative unit contact of the plurality of unit electrical contacts and aligning one of the first positive electrical contact and the second positive electrical contact with a positive unit contact of the plurality of unit electrical contacts.

20. The method of claim 15 further comprising neutralizing the contacts of the plurality of second electrical contacts that are not aligned with any electrical contacts of the plurality of unit electrical contacts.
